(19) United States
(12) Patent Application Publication
(10) Pub. No.: US 2012/0188314 A1
(43) Pub. Date: Jul. 26, 2012

(54) INKJET PRINTING APPARATUS

(75) Inventors: Tomoyuki AKIYAMA, Ibaraki-ken (JP); Masaaki SHINOHARA, Ibaraki-ken (JP)

(73) Assignee: RISO KAGAKU CORPORATION, Tokyo (JP)

(21) Appl. No.: 13/339,771

(22) Filed: Dec. 29, 2011

(30) Foreign Application Priority Data
Jan. 24, 2011 (JP) 2011-011703

(51) Int. Cl. B41J 2/175

(52) U.S. Cl. 347/85

(57) ABSTRACT

An inkjet printing apparatus includes: an inkjet head configured to discharge ink; a first tank configured to store ink to be supplied to the inkjet head; a second tank configured to store ink not consumed by the inkjet head; an ink circulation path for circulation of ink among the first tank, the inkjet head, and the second tank; a pressurizer configured to provide the first and second tanks with a pressure for the circulation of ink through the ink circulation path; a first pressure adjuster configured to adjust a pressure inside the first tank during the circulation of ink; and a second pressure adjuster configured to adjust a pressure inside the second tank during the circulation of ink.

### CROSS REFERENCE TO RELATED APPLICATION

This application is based upon and claims the benefit of priority from the prior Japanese Patent Application No. 2011-011703, filed on Jan. 24, 2011, the entire contents of which are incorporated herein by reference.

### BACKGROUND OF THE INVENTION

1. Field of the Invention

The present invention relates to an inkjet printing apparatus configured to make print on a printing medium by discharging ink from an inkjet head.

2. Description of the Related Art

An ink circulation type inkjet printing apparatus has heretofore been known.

An ink circulation type inkjet printing apparatus in a related art disclosed in Japanese Unexamined Patent Application Publication No. 2009-297961 includes an inkjet head and ink tanks respectively located upstream and downstream of the inkjet head. These ink tanks are connected to each other through a pipe. An ink is supplied from the ink tank on the upstream side (an upstream tank) to the inkjet head, and then is discharged. The ink not consumed by the inkjet head is collected by the ink tank on the downstream side (a downstream tank).

In this inkjet printing apparatus, the inkjet head is located in a higher position than the downstream tank while the upstream tank is located in a higher position than the inkjet head. The supply of the ink from the upstream tank to the inkjet head and the collection of the ink from the inkjet head to the downstream tank are performed by way of water head differences based on this positional relationship. The ink stored in the downstream tank is sent to the upstream tank by a pump.

### SUMMARY OF THE INVENTION

In the case of a high-resolution inkjet head including densely arranged nozzles, ink flow passages inside the inkjet head are narrow and flow passage resistance is thereby high. Accordingly, a high pressure needs to be applied to the inkjet head in order to achieve a necessary ink flow rate in the inkjet head.

According to the above-described ink circulation type inkjet printing apparatus, it is necessary to provide a large difference in height between the inkjet head and the upstream tank in order to increase the pressure to be applied to the inkjet head. However, this arrangement leads to an increase in size of the apparatus. A similar problem may be encountered in a case where high viscosity ink is used, or the like.

As described above, in the ink circulation type inkjet printing apparatus in the related art, the apparatus needs to be increased in size in order to properly adjust the pressure to the inkjet head.

An object of the present invention is to provide an ink circulation type inkjet printing apparatus which is capable of suppressing an increase in size of the apparatus and properly adjusting a pressure to be applied to an inkjet head.

An aspect of the present invention is an inkjet printing apparatus comprising: an inkjet head configured to discharge ink; a first tank configured to store ink to be supplied to the inkjet head; a second tank configured to store ink not consumed by the inkjet head; an ink circulation path for circulation of ink among the first tank, the inkjet head, and the second tank; a pressurizer configured to provide the first and second tanks with a pressure for the circulation of ink through the ink circulation path; a first pressure adjuster configured to adjust a pressure inside the first tank during the circulation of ink; and a second pressure adjuster configured to adjust a pressure inside the second tank during the circulation of ink.

According to this aspect, the pressurizer applies pressures to the first and second tanks in order to circulate the ink while the first and second pressure adjusters adjust the pressures inside the first and second tanks during circulation of the ink. In this way, the pressure to the inkjet head can be adjusted without depending on a difference in height between the first tank and the inkjet head. Hence it is possible to suppress an increase in size of the apparatus and to properly adjust the pressure to the inkjet head.

The first tank and the second tank may be arranged in positions such that liquid surfaces of ink stored in the first and second tanks are located at almost the same height in a vertical direction in a state open to the air and are located lower than an ink discharge surface of the inkjet head.

According to this configuration, the first tank and the second tank are arranged in positions such that the liquid surfaces of the stored ink in the first and second tanks are located at almost the same height in the vertical direction in a state open to the air and are located lower than the ink discharge surface of the inkjet head. In this way, no ink flows between the tanks even when the first and second tanks are opened to the air during stand-by, and the ink is prevented from overflowing from the nozzles on the inkjet head. Hence it is possible to hold the ink stably.

The first pressure adjuster and the second pressure adjuster may be formed as a single unit.

According to this configuration, the first pressure adjuster and the second pressure adjuster are formed as a single unit. Hence it is possible to downsize the apparatus.

### BRIEF DESCRIPTION OF THE DRAWINGS

FIG. 1 is a schematic configuration diagram of an inkjet printing apparatus according to an embodiment of the present invention.

FIG. 2 is a block diagram showing a configuration of a control system of the inkjet printing apparatus shown in FIG. 1.

FIG. 3 is a flowchart for explaining a printing operation using the inkjet printing apparatus shown in FIG. 1.

FIG. 4 is a flowchart for explaining a liquid surface keeping operation of the inkjet printing apparatus shown in FIG. 1.

FIG. 5 is a schematic configuration diagram of an inkjet printing apparatus according to a modified example of the embodiment of the present invention.

FIG. 6 is a cross-sectional view showing a configuration of a pressure adjuster in the inkjet printing apparatus shown in FIG. 5.

### DETAILED DESCRIPTION OF THE EMBODIMENT

An embodiment of the present invention will be described below with reference to the accompanying drawings. Throughout the drawings, identical or similar regions and constituents are denoted by identical or similar reference numerals. It is to be noted, however, that the drawings are merely schematic and may be different from actual configurations.

Moreover, the embodiment to be described below merely illustrates an apparatus and the like embodying the technical idea of the present invention and the technical idea of the present invention does not limit layouts and the like of the respective constituents only to the following description. Various modifications can be added to the technical idea of the present invention without departing from the scope as defined in the appended claims.

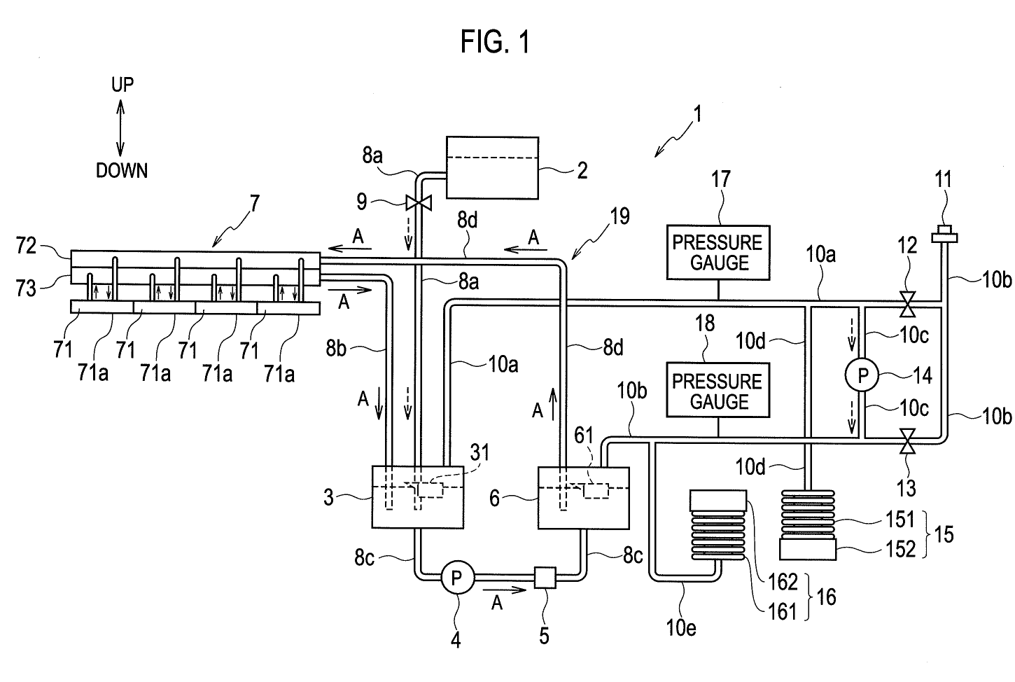

FIG. 1 is a schematic configuration diagram of an inkjet printing apparatus according to an embodiment of the present invention. Note that an up and down direction in the following description means a vertical direction, which is equivalent to the up and down direction shown in FIG. 1.

As shown in FIG. 1, an inkjet printing apparatus 1 according to the embodiment of the present invention includes an ink bottle 2, a downstream tank 3 (a second tank), an ink pump 4, an ink filter 5, an upstream tank 6 (a first tank), an inkjet head 7, ink pipes 8a to 8d, an ink supply valve 9, air pipes 10a to 10e, an air filter 11, a downstream tank air open valve 12, an upstream tank air open valve 13, an air pump 14 (a pressurizer), a downstream tank pressure adjuster 15 (a second pressure adjuster), an upstream tank pressure adjuster 16 (a first pressure adjuster), and pressure gauges 17 and 18.

The ink bottle 2 holds ink used for printing with the inkjet printing apparatus 1. The ink inside the ink bottle 2 is supplied to the downstream tank 3 via the ink pipe 8a.

The downstream tank 3 is configured to store the ink supplied from the ink bottle 2. The downstream tank 3 stores the ink which is not consumed by a discharge operation of the inkjet head 7.

The downstream tank 3 is located below (in a lower position than) the ink bottle 2. The downstream tank 3 is arranged in position such that the highest liquid surface of the stored ink still remains below an ink discharge surface 71a of the inkjet head 7. The ink is supplied from the ink bottle 2 to the downstream tank 3 via the ink pipe 8a. The ink not consumed by the inkjet head 7 is collected by the downstream tank 3 via the ink pipe 8b. The downstream tank 3 can be opened to the air via the air pipes 10a and 10b.

The downstream tank 3 is provided with a downstream tank liquid surface sensor 31. The downstream tank liquid surface sensor 31 is configured to output a signal indicating “ON” when the level of the ink surface inside the downstream tank 3 is equal to or above a height H1 being a lower limit and to output a signal indicating “OFF” when the level is below the height H1.

The ink pump 4 is configured to send the ink from the downstream tank 3 to the upstream tank 6 via the ink pipe 8c. The ink pump 4 is provided midway in the ink pipe 8c.

The ink filter 5 is configured to remove foreign particles, bubbles, and the like in the ink flowing inside the ink pipe 8c. The ink filter 5 is provided midway in the ink pipe 8c.

The upstream tank 6 is configured to store the ink to be supplied to the inkjet head 7. The ink in the upstream tank 6 is supplied to the inkjet head 7 via the ink pipe 8d. The ink is supplied from the downstream tank 3 to the upstream tank 6 via the ink pipe 8c by driving the ink pump 4.

The upstream tank 6 is provided at almost the same height as the downstream tank 3 in the vertical direction and is arranged in position such that the highest liquid surface of the stored ink still remains below the ink discharge surface 71a of the inkjet head 7. The upstream tank 6 can be opened to the air via the air pipe 10b.

The upstream tank 6 is provided with an upstream tank liquid surface sensor 61. The upstream tank liquid surface sensor 61 is configured to output a signal indicating “ON” when the level of the ink surface inside the upstream tank 6 is equal to or above a height H2 being a lower limit and to output a signal indicating “OFF” when the level is below the height H2.

The upstream tank 6 and the downstream tank 3 are opened to the air when the ink is not circulated (during the stand-by). Here, the upstream tank 6 and the downstream tank 3 are arranged in positions in which the liquid surfaces of the ink in the tanks are located at almost the same height in a vertical direction in the state open to the air. Note that the upstream tank 6 and the downstream tank 3 may be formed as a single unit.

The inkjet head 7 is configured to print an image by discharging the ink that is supplied from the upstream tank 6 onto a printing medium such as print paper. The inkjet head 7 includes multiple unit heads 71, a distributor 72, and a collector 73.

Each of the unit heads 71 includes multiple nozzles, an ink chamber, and an ink discharge mechanism (none of these are shown). The ink discharge mechanism is configured to discharge the ink from the nozzles by deforming the ink chamber using piezoelectric elements, for example.

The distributor 72 is configured to distribute the ink supplied from the upstream tank 6 via the ink pipe 8d to each of the unit heads 71.

The collector 73 is configured to collect the ink which is not consumed by ink discharge operations of the respective unit heads 71. The ink collected by the collector 73 flows to the downstream tank 3 via the ink pipe 8b.

The inkjet head 7 is arranged such that the ink discharge surfaces (nozzle surfaces) 71a of the unit heads 71 are located above (in a higher position than) the liquid surfaces of the ink stored in the downstream tank 3 and the upstream tank 6.

The ink pipe 8a is configured to connect the ink bottle 2 to the downstream tank 3. The ink flows through the ink pipe 8a from the ink bottle 2 toward the downstream tank 3.

The ink pipe 8b is configured to connect the collector 73 of the inkjet head 7 to the downstream tank 3. The ink flows through the ink pipe 8b from the collector 73 toward the downstream tank 3.

The ink pipe 8c is configured to connect the downstream tank 3 to the upstream tank 6. The ink flows through the ink pipe 8c from the downstream tank 3 toward the upstream tank 6 by driving the ink pump 4.

The ink pipe 8d is configured to connect the upstream tank 6 to the distributor 72 of the inkjet head 7. The ink flows through the ink pipe 8d from the upstream tank 6 toward the distributor 72.

The ink pipes 8b to 8d collectively constitute an ink circulation path 19 for circulating the ink among the upstream tank 6, the inkjet head 7, and the downstream tank 3. The ink flows in this ink circulation path 19 in a direction indicated with an arrow A.

The ink supply valve 9 is provided on the ink pipe 8a and is configured to open and close a flow passage of the ink inside the ink pipe 8a. When the ink supply valve 9 is open, the ink is supplied from the ink bottle 2 to the downstream tank 3.

One end of the air pipe 10a is connected to the downstream tank 3 while the other end thereof is connected to the air pipe 10b. The downstream tank 3 can be opened to the air through the air pipes 10a and 10b.

One end of the air pipe 10b is connected to the upstream tank 6 while the other end (the open end) thereof is communicated with the air via the air filter 11.

One end of the air pipe 10c is connected to the air pipe 10a while the other end thereof is connected to the air pipe 10b. The air is sent from the air pipe 10a to the air pipe 10b via the air pipe 10c by driving the air pump 14. The one end of the air pipe 10c is connected to the air pipe 10a in a position closer to the downstream tank 3 than the downstream tank air open valve 12. The other end of the air pipe 10c is connected to the air pipe 10b in a position closer to the upstream tank 6 than the upstream tank air open valve 13.

One end of the air pipe 10d is connected to the air pipe 10a while the other end thereof is connected to the downstream tank pressure adjuster 15. The one end of the air pipe 10d is connected to the air pipe 10a in a position closer to the downstream tank 3 than the downstream tank air open valve 12.

One end of the air pipe 10e is connected to the air pipe 10b while the other end thereof is connected to the upstream tank pressure adjuster 16. The one end of the air pipe 10e is connected to the air pipe 10b in a position closer to the upstream tank 6 than the upstream tank air open valve 13.

The air filter 11 is provided on the open end of the air pipe 10b and is configured to prevent entry of the foreign particles and the like in the outside air.

The downstream tank air open valve 12 is provided on the air pipe 10a and is configured to open and close the flow passage of the air inside the air pipe 10a. The downstream tank 3 is opened to the air when the downstream tank air open valve 12 is opened. The downstream tank air open valve 12 is closed during circulation of the ink (during a printing operation) and the downstream tank air open valve 12 is opened when the ink is not circulated (during the stand-by).

The upstream tank air open valve 13 is provided on the air pipe 10b and is configured to open and close the flow passage of the air inside the air pipe 10b. The upstream tank 6 is opened to the air when the upstream tank air open valve 13 is opened. The upstream tank air open valve 13 is closed during circulation of the ink (during a printing operation) and the upstream tank air open valve 13 is opened when the ink is not circulated (during the stand-by).

The air pump 14 is provided midway in the air pipe 10c and is configured to apply a pressure for circulating the ink via the ink circulation path 19 to the upstream tank 6 and to the downstream tank 3. To be more precise, when circulation of the ink is started, the air pump 14 is driven while both of the downstream tank air open valve 12 and the upstream tank air open valve 13 are closed, so as to send the air from the downstream tank 3 side (the air pipe 10a side) toward the upstream tank 6 side (the air pipe lob side). In this way, the air pump 14 reduces the pressure in the downstream tank 3 while increasing the pressure in the upstream tank 6. Accordingly, the ink inside the upstream tank 6 is sent to the inkjet head 7 via the ink pipe 8d.

The downstream tank pressure adjuster 15 is configured to adjust the pressure inside the downstream tank 3 to a constant level during circulation of the ink (during the printing operation). The downstream tank pressure adjuster 15 includes a bellows 151 and a weight 152.

An opening on an upper end of the bellows 151 is connected to the other end of the air pipe 10d and an internal space of the bellows 151 is communicated with the inside of the downstream tank 3 by way of the air pipes 10d and 10a. A lower end of the bellows 151 is occluded. The bellows 151 is made of an elastic material and is allowed to expand and contract in the up and down direction while the volume of the internal space changes in accordance with the expansion and contraction.

The weight 152 is attached to the lower end of the bellows 151. The weight 152 is located in a predetermined initial position when the ink is not circulated (during the stand-by), so as to expand the bellows 151 to a predetermined length. When circulation of the ink is started, the pressure inside the downstream tank 3 and inside the bellows 151 communicated therewith is reduced, and the weight 152 is thus lifted up from the initial position. During circulation of the ink, the weight 152 is in the state of being lifted up from the initial position so as to maintain an upward force applying to the weight 152 by way of the pressure (a negative pressure) inside the bellows 151 and the downstream tank 3 to be balanced with the gravity of the weight 152. Even when the volume of the air inside the downstream tank 3 fluctuates due to a vertical movement of the liquid surface of the ink in the downstream tank 3, fluctuation of the pressure inside the bellows 151 and the downstream tank 3 is suppressed because the bellows 151 is expanded or contracted so as to absorb the fluctuation.

The upstream tank pressure adjuster 16 is configured to adjust the pressure inside the upstream tank 6 to a constant level during circulation of the ink (during the printing operation). The upstream tank pressure adjuster 16 includes a bellows 161 and a weight 162.

An opening on a lower end of the bellows 161 is connected to the other end of the air pipe 10e and an internal space of the bellows 161 is communicated with the inside of the upstream tank 6 by way of the air pipes 10e and 10b. An upper end of the bellows 161 is occluded. The bellows 161 is made of an elastic material and is allowed to expand and contract in the up and down direction while the volume of the internal space changes in accordance with the expansion and contraction.

The weight 162 is attached to the upper end of the bellows 161. The weight 162 is located in a predetermined initial position when the ink is not circulated (during the stand-by), so as to compress the bellows 161. When circulation of the ink is started, the pressure inside the upstream tank 6 and inside the bellows 161 in communication therewith is increased, and the weight 162 is thus lifted up from the initial position. During circulation of the ink, the weight 162 is in the state of being lifted up from the initial position so as to maintain an upward force applying to the weight 162 by way of the pressure (a positive pressure) inside the bellows 161 and the upstream tank 6 to be balanced with the gravity of the weight 162. Even when the volume of the air inside the upstream tank 6 fluctuates due to a vertical movement of the liquid surface of the ink in the upstream tank 6, fluctuation of the pressure inside the bellows 161 and the upstream tank 6 is suppressed because the bellows 161 is expanded or contracted so as to absorb the fluctuation.

The pressure gauges 17 and 18 are configured to measure the pressures inside the downstream tank 3 and inside the upstream tank 6, respectively. The pressure gauge 17 is provided on the air pipe 10a in a position closer to the downstream tank 3 than the downstream tank air open valve 12. The pressure gauge 18 is provided on the air pipe 10b in a position closer to the upstream tank 6 than the upstream tank air open valve 13. When circulation of the ink is started, the downstream tank air open valve 12 and the upstream tank air open valve 13 are closed. Hence it is possible to measure the pressures inside the air pipe 10a and inside the air pipe 10b as the pressures inside the downstream tank 3 and inside the upstream tank 6, respectively. Note that the pressure gauges 17 and 18 may be provided in any places as long as these gauges can measure the pressures inside the downstream tank 3 and inside the upstream tank 6.

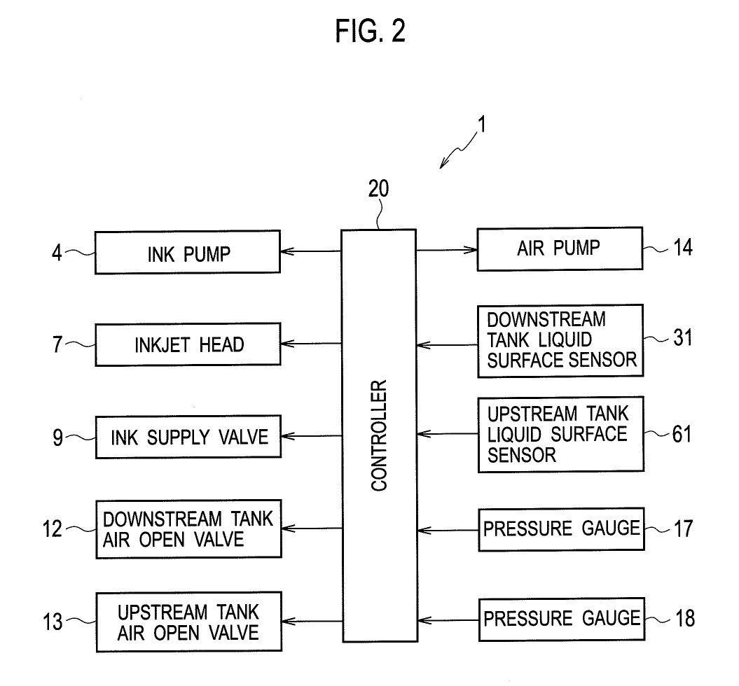

FIG. 2 is a block diagram showing a configuration of a control system of the inkjet printing apparatus 1. As shown in FIG. 2, the inkjet printing apparatus 1 includes a controller 20.

The controller 20 includes a CPU, a ROM, a RAM (none of these are shown), and so forth. The controller 20 controls operations of the ink pump 4, the inkjet head 7, the ink supply valve 9, the downstream tank air open valve 12, the upstream tank air open valve 13, and the air pump 14. Output terminals of the downstream tank liquid surface sensor 31, the upstream tank liquid surface sensor 61, and the pressure gauges 17 and 18 are connected to the controller 20.

Next, operations of the inkjet printing apparatus 1 will be described.

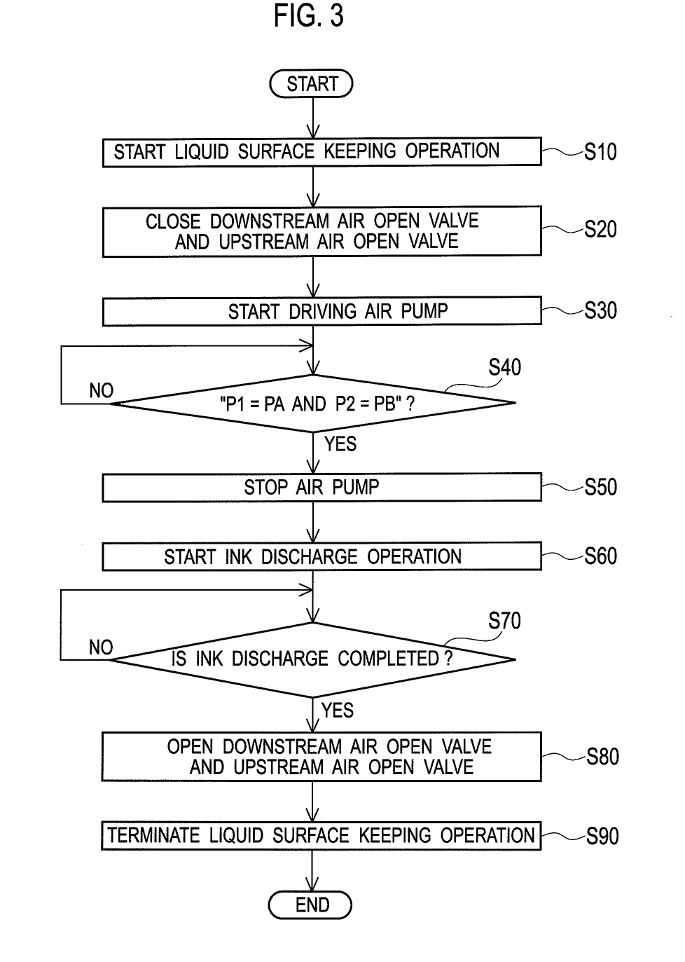

FIG. 3 is a flowchart for explaining a printing operation using the inkjet printing apparatus shown in FIG. 1.

First, in step S10, the controller 20 starts a liquid surface keeping operation. This liquid surface keeping operation will be described later.

Subsequently, in step S20, the controller 20 performs control so as to close both of the downstream tank air open valve 12 and the upstream tank air open valve 13.

Next, the controller 20 starts driving the air pump 14 in step S30. In this way, the air is sent from the downstream tank 3 to the upstream tank 6 so as to reduce the pressure inside the downstream tank 3 and to increase the pressure inside the upstream tank 6. As a consequence, there occurs a difference in the pressure between the downstream tank 3 and the upstream tank 6 whereby the ink begins to flow from the upstream tank 6 to the downstream tank 3 via the ink pipe 8d, the inkjet head 7, and the ink pipe 8b. Meanwhile, the pressure inside the bellows 151 of the downstream tank pressure adjuster 15 communicated with the downstream tank 3 is reduced and the pressure inside the bellows 161 of the upstream tank pressure adjuster 16 communicated with the upstream tank 6 is increased. In this way, the weight 152 of the downstream tank pressure adjuster 15 and the weight 162 of the upstream tank pressure adjuster 16 are respectively lifted up from the initial positions.

Then, in step S40, the controller 20 judges whether or not a pressure P1 inside the downstream tank 3 is set equal to a predetermined negative pressure PA and a pressure P2 inside the upstream tank 6 is set equal to a predetermined positive pressure PB. The negative pressure PA and the positive pressure PB are the values which are preset as the appropriate pressures for circulating the ink through the ink circulation path 19 and discharging the ink stably from the inkjet head 7. The controller 20 repeats the processing in step S40 when judging that the “P1=PA and P2=PB” is not satisfied (NO in step S40).

When judging that the “P1=PA and P2=PB” is satisfied (YES in step S40), the controller 20 stops the air pump 14 in step S50. In this way, the state of circulation where the ink circulates through the ink circulation path 19 is established. Here, it is also possible to drive the air pump 14 just for a preset time period without using the pressure gauges 17 and 18.

Subsequently, in step S60, the controller 20 starts an operation to discharge the ink from the inkjet head 7 based on image data. The ink is supplied from the upstream tank 6 to the inkjet head 7 via the ink pipe 8d, and the ink which is not consumed during the ink discharge operations of the unit heads 71 flows to the downstream tank 3 via the ink pipe 8b.

During the ink discharge operations, the liquid surfaces of the ink inside the downstream tank 3 and inside the upstream tank 6 fluctuate because of transfer of the ink from the upstream tank 6 to the downstream tank 3, consumption of the ink by way of discharge from the unit heads 7, and the liquid surface keeping operation to be described later. Meanwhile, in the inkjet printing apparatus 1, even when the liquid surfaces of the ink fluctuate, the pressures inside the downstream tank 3 and inside the upstream tank 6 are kept constantly at the negative pressure PA and the positive pressure PB by way of the downstream tank pressure adjuster 15 and the upstream tank pressure adjuster 16. In this way, the pressure difference between the downstream tank 3 and the upstream tank 6 is kept appropriately.

In step S70, the controller 20 judges whether or not the ink discharge based on the image data is completed. When judging that the ink discharge is not completed yet (NO in step S70), the controller 20 repeats the processing in step S70.

When judging that the ink discharge is completed (YES in step S70), the controller 20 performs control in step S80 so as to open the downstream tank air open valve 12 and then to open the upstream tank air open valve 13. By opening the downstream tank air open valve 12 earlier than the upstream tank air open valve 13, it is possible to prevent the negative pressure at the nozzles of the inkjet head 7 from growing too large and suctioning the air. The downstream tank 3 and the upstream tank 6 are opened to the air as the downstream tank air open valve 12 and the upstream tank air open valve 13 are opened, and the state of circulation of the ink is thereby terminated.

Thereafter, in step S90, the controller 20 terminates the liquid surface keeping operation. Accordingly, the inkjet printing apparatus 1 terminates the printing operation and transitions to the stand-by state.

Here, if there is a difference in the liquid surface between the downstream tank 3 and the upstream tank 6 at the point of transition of the inkjet printing apparatus 1 from the state of circulation to the stand-by state, the ink gradually moves through the ink pipes 8b and 8d and the inkjet head 7. Then, the liquid surfaces in both of the tanks become almost the same in the end.

Next, the liquid surface keeping operation will be described. The liquid surface keeping operation is carried out in order to keep the liquid surfaces in both of the tanks and the amount of the ink to be circulated by driving the ink pump 4 and supplying the ink based on outputs from the downstream tank liquid surface sensor 31 and the upstream tank liquid surface sensor 61.

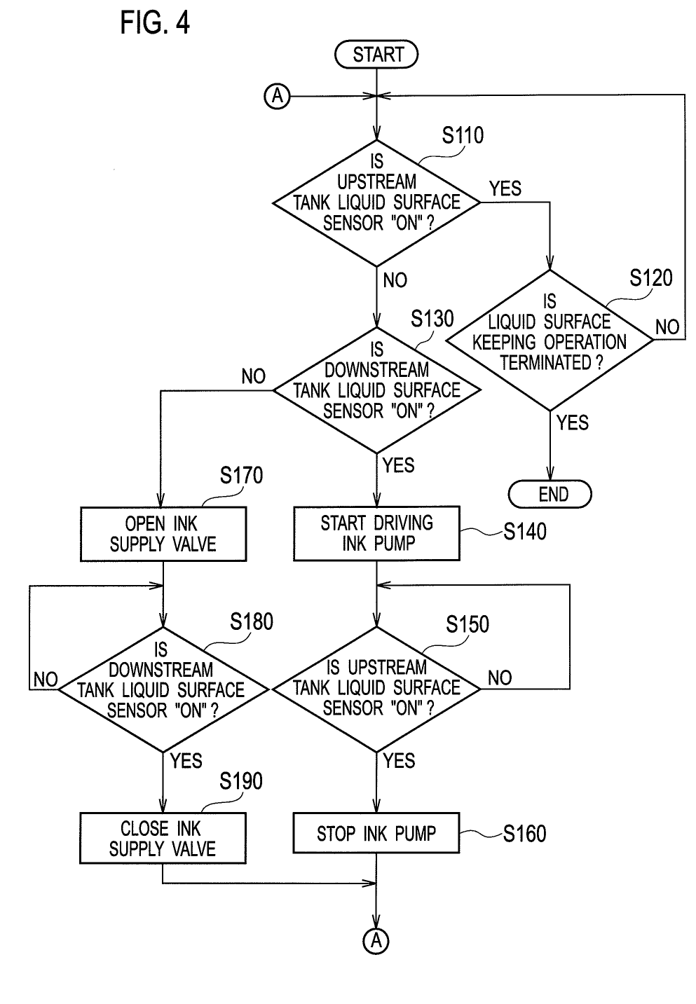

FIG. 4 is a flowchart for explaining the liquid surface keeping operation of the inkjet printing apparatus 1. First, in step S110, the controller 20 judges whether or not the output from the upstream tank liquid surface sensor 61 is “ON.”

When judging that the output from the upstream tank liquid surface sensor 61 is “ON” (YES in step S110), the controller 20 judges whether or not it is appropriate to terminate the liquid surface keeping operation in step S120. When the series of the above-described processing to step S80 in FIG. 3 is completed, the controller 20 judges that it is appropriate to terminate the liquid surface keeping operation. The controller 20 terminates the processing without performing other processing upon a judgment that it is appropriate to terminate the liquid surface keeping operation (YES in step S120), or returns to step S110 upon a judgment that it is not appropriate to terminate the liquid surface keeping operation (NO in step S120).

When judging that the output from the upstream tank liquid surface sensor 61 is “OFF” (NO in step S110), the controller 20 judges whether or not the output from the downstream tank liquid surface sensor 31 is “ON” in step S130.

When judging that the output from the downstream tank liquid surface sensor 31 is “ON” (YES in step S130), the controller 20 starts driving the ink pump 4 in step S140. In this way, the ink is supplied from the downstream tank 3 to the upstream tank 6 via the ink pipe 8c.

Subsequently, in step S150, the controller 20 judges whether or not the output from the upstream tank liquid surface sensor 61 is “ON.” When judging that the output from the upstream tank liquid surface sensor 61 is “OFF” (NO in step S150), the controller 20 repeats the processing in step S150.

When judging that the output from the upstream tank liquid surface sensor 61 is “ON” (YES in step S150), the controller 20 stops the ink pump 4 in step S160. In this way, the supply of the ink from the downstream tank 3 to the upstream tank 6 is stopped. Then, the controller 20 returns to the step S110 and repeats the processing thereafter.

On the other hand, when the judging in step S130 that the output from the downstream tank liquid surface sensor 31 is “OFF” (NO in step S130), the controller 20 controls to open the ink supply valve 9 in step S170. In this way, the supply of the ink from the ink bottle 2 to the downstream tank 3 through the ink pipe 8a is started.

Subsequently, in step S180, the controller 20 judges whether or not the output from the downstream tank liquid surface sensor 31 is “ON.” When judging that the output from the downstream tank liquid surface sensor 31 “OFF” (NO in step S180), the controller 20 repeats the processing in step S180.

When judging that the output from the downstream tank liquid surface sensor 31 is “ON” (YES in step S180), the controller 20 controls to close the ink supply valve 9 in step S190. In this way, the supply of the ink from the ink bottle 2 to the downstream tank 3 is stopped. Then, the controller 20 returns to the step S110 and repeats the processing thereafter.

As described above, according to the inkjet printing apparatus 1 of this embodiment, the pressures are applied to the downstream tank 3 and the upstream tank 6 by using the air pump 14 when circulation of the ink is started, and the pressures are kept by use of the downstream tank pressure adjuster 15 and the upstream tank pressure adjuster 16 during circulation of the ink. The pressure to the inkjet head 7 can be set up to a desired pressure by adjusting the materials of the bellows 151 and 161 as well as the amounts of the weights 152 and 162 of the downstream tank pressure adjuster 15 and the upstream tank pressure adjuster 16, and so forth. In the ink circulation type inkjet printing apparatus of the related art, the upstream tank is located in the higher position than the inkjet head so as to apply the pressure to the inkjet head by way of the water head difference. For this reason, it is necessary to provide a large difference in height between the inkjet head and the upstream tank in order to increase the pressure to be applied to the inkjet head. As a consequence, there arises the problem of the increase in size of the apparatus. On the other hand, according to the inkjet printing apparatus 1 of this embodiment, the pressure to the inkjet head 7 can be adjusted without depending on the difference in height between the upstream tank 6 and the inkjet head 7. Hence it is possible to adjust the pressure to the inkjet head 7 appropriately while suppressing the increase in size of the apparatus.

Moreover, according to the inkjet printing apparatus 1, the downstream tank pressure adjuster 15 and the upstream tank pressure adjuster 16 absorb the pressure fluctuation inside the downstream tank 3 and inside the upstream tank 6 attributable to pulsation of the ink pump 4. Accordingly, it is possible to suppress instability of the negative pressure at the nozzles of the inkjet head 7 due to the influence of the pulsation of the ink pump 4

In the inkjet printing apparatus 1 of this embodiment the downstream tank 3 and the upstream tank 6 are located at almost the same height, but there may be a difference in height between these tanks. Nevertheless, in this case, the air open valve (either the downstream tank air open valve 12 or the upstream tank air open valve 13) of an upper one of the downstream tank 3 and the upstream tank 6 needs to be closed to establish a hermetically sealed state of the upper tank during the stand-by. This operation is necessary for preventing the ink from flowing from the upper tank to the lower tank during the stand-by. However, even when the air open valve of the upper tank is closed during the stand-by, the ink still may flow from the upper tank to the lower tank due to air leakage and thereby overflow from the lower tank.

For this reason, in the above-described inkjet printing apparatus 1, the downstream tank 3 and the upstream tank 6 are arranged at almost the same height at which the liquid surfaces of the ink in the two tanks are located at almost the same height when the tanks are opened to the air. Thus, the two tanks can be opened to the air during the stand-by. As a consequence, it is possible to prevent the above-described overflow attributable to the ink flowing to the lower tank.

According to the inkjet printing apparatus 1 of this embodiment, the liquid surfaces of the ink inside the downstream tank 3 and the upstream tank 6 are set to the lower positions than the ink discharge surface 71a. In this way, it is possible to prevent the ink from overflowing from the nozzles of the unit heads 71 of the inkjet head 7 even when both of the tanks are opened to the air during the stand-by. If the liquid surfaces of the ink inside the downstream tank 3 and the upstream tank 6 are located in higher positions than the ink discharge surface 71a, the ink may flow from both of the tanks to the inkjet head 7 when the tanks are opened to the air, and thereby overflow from the nozzles.

As described above, since the upstream tank 6 and the downstream tank 3 are arranged in the positions which are lower than the ink discharge surface 71a and in which the liquid surfaces of the ink therein are located at almost the same height in the state open to the air, the inkjet printing apparatus 1 can hold the ink stably during the stand-by.

However, if the liquid surfaces of the ink inside the downstream tank 3 and inside the upstream tank 6 are too low with respect to the ink discharge surface 71a, the negative pressure to be applied to the nozzles of the unit heads 71 may grow too large due to the water head difference during the stand-by, and this excessive negative pressure may destroy meniscus on the nozzles and allow entry of the air into the nozzles. Therefore, the positions in the up and down directions of the downstream tank 3 and the upstream tank 6 need to be appropriately set up.

### MODIFIED EXAMPLE

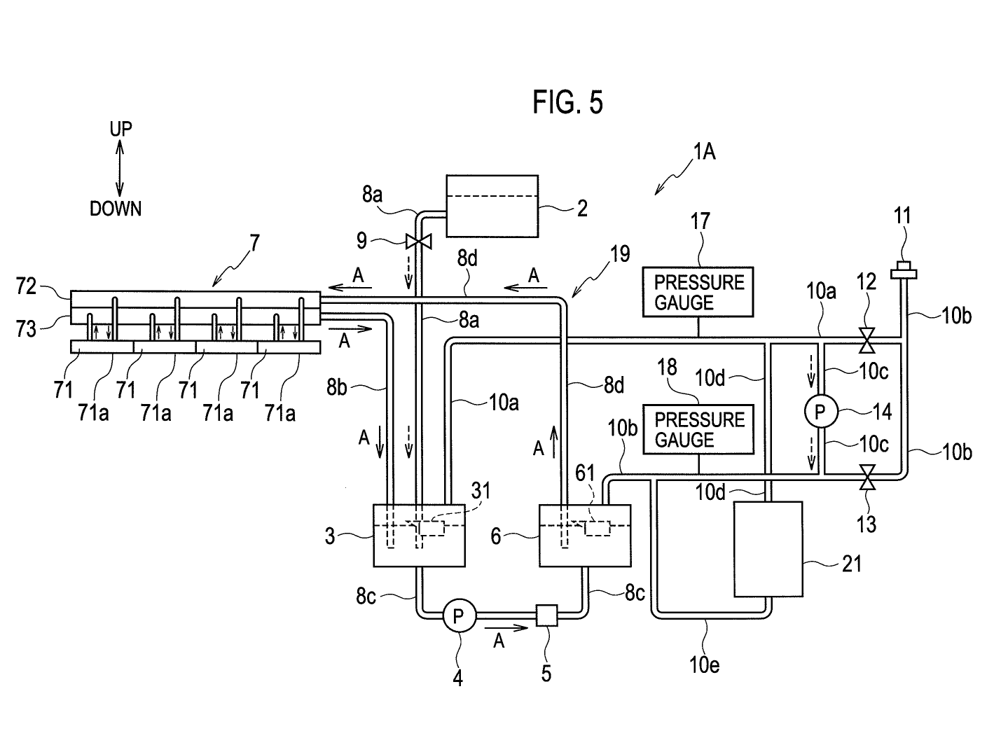

FIG. 5 is a schematic configuration diagram of an inkjet printing apparatus 1A according to a modified example of the embodiment of the present invention.

As shown in FIG. 5, the inkjet printing apparatus 1A according to this modified example adopts a configuration obtained by omitting the downstream tank pressure adjuster 15 and the upstream tank pressure adjuster 16 from the inkjet printing apparatus 1 shown in FIG. 1, and adding a pressure adjuster 21 (serving as the first and second pressure adjusters) instead.

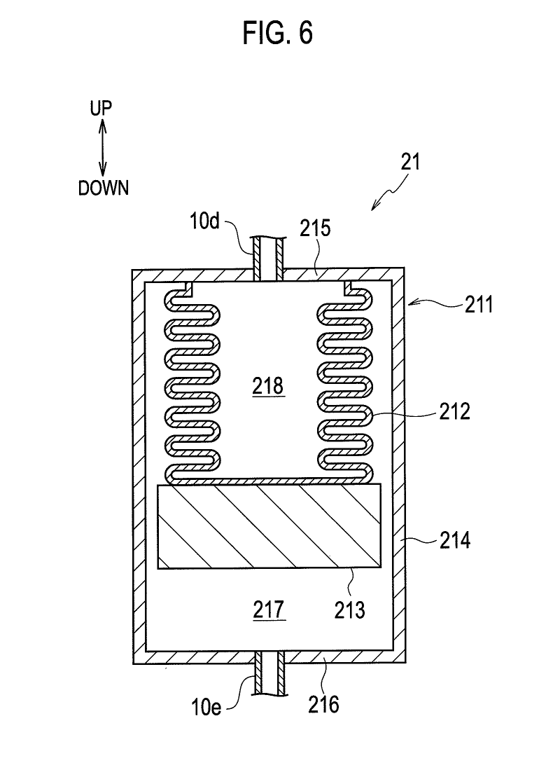

FIG. 6 is a cross-sectional view showing a configuration of the pressure adjuster 21. FIG. 6 shows a cross section taken along a central axis of the pressure adjuster 21. The pressure adjuster 21 has the function as the first pressure adjuster configured to adjust the pressure inside the upstream tank 6 and the function as the second pressure adjuster configured to adjust the pressure inside the downstream tank 3 during circulation of the ink (during the printing operation). That is, the pressure adjuster 21 is equivalent to integration of the first pressure adjuster and the second pressure adjuster. The pressure adjuster 21 includes a bellows cover 211, a bellows 212, and a weight 213.

The bellows cover 211 is provided with a cylindrical barrel 214, a top plate 215 configured to occlude an upper end of the barrel 214, and a bottom plate 216 configured to occlude a lower end of the barrel 214, and is thereby formed into an airtight container. The other end of the air pipe 10d is connected to the top plate 215 while the other end of the air pipe 10e is connected to the bottom plate 216. An internal space 217 of the bellows cover 211 is communicated with the inside of the upstream tank 6 via the air pipes 10e and 10b.

An opening on an upper end of the bellows 212 is connected to the top plate 215 and an internal space 218 of the bellows 212 is communicated with the inside of the downstream tank 3 by way of the air pipes 10d and 10a. A lower end of the bellows 212 is occluded. The bellows 212 is made of an elastic material and is allowed to expand and contract in the up and down direction while the volume of the internal space 218 changes in accordance with the expansion and contraction. Since the bellows 212 and the weight 213 are provided inside the bellows cover 211, the volume of the internal space 217 of the bellows cover 211 is also changed in conjunction with the expansion and contraction of the bellows 212.

The weight 213 is connected to the lower end of the bellows 212. The weight 213 is placed on the bottom plate 216 when the ink is not circulated (during the stand-by). When circulation of the ink is started, the pressure inside the downstream tank 3 and the internal space 218 of the bellows 212 communicated with the downstream tank 3 is reduced while the pressure inside the upstream tank 6 and the internal space 217 of the bellows cover 211 communicated with the upstream tank 6 is increased. Hence the weight 213 is lifted up from the bottom plate 216. During circulation of the ink, the weight 213 remains lifted up from the bottom plate 216. Then, a sum of an upward force to be applied to the weight 213 by way of the pressure (the negative pressure) inside the internal space 218 of the bellows 212 as well as the downstream tank 3 and an upward force to be applied to the weight 213 by way of the pressure (the positive pressure) inside the internal space 217 of the bellows cover 211 as well as the upstream tank 6 is maintained so as to be balanced with the gravity of the weight 213.

Even when the volumes of the air inside both of the tanks fluctuate due to the vertical movements of the liquid surfaces of the ink in the downstream tank 3 and the upstream tank 6, the pressure fluctuation in the internal spaces 217 and 218, inside the downstream tank 3, and inside the upstream tank 6 is suppressed because the volumes of the internal space 218 of the bellows 212 and the internal space 217 of the bellows cover 211 change along with expansion and contraction of the bellows 212 in response to the vertical movements.

According to the inkjet printing apparatus 1A of this modified example, the pressure adjustment in the downstream tank 3 and the upstream tank 6 is achieved by the single pressure adjuster 21. Hence it is possible to obtain an effect to enable further downsizing of the apparatus in addition to the effect similar to that of the inkjet printing apparatus 1 in FIG. 1 described in conjunction with the embodiment.

In the pressure adjuster 21, the volumes of the internal space 218 of the bellows 212 and of the internal space 217 of the bellows cover 211 are changed in tandem. Accordingly, the pressure difference between both of the tanks can be easily kept within a predetermined range.

The pressure adjuster 21 is configured to change the volumes of the internal spaces 217 and 218 in tandem. Accordingly, the pressure difference between both of the tanks may fall outside the predetermined range due to a brief significant change in the liquid surface of the ink inside one of the tanks such as a case when the ink is supplied from the ink bottle 2 to the downstream tank 3. However, this is a temporary behavior and the pressure adjuster 21 can keep the pressure difference between both of the tanks within the predetermined range as a whole in the state of circulation of the ink. In particular, the pressure adjuster 21 can keep the pressure difference between both of the tanks always at a constant level as long as the amount of circulated ink is constant as in the case of a warm-up operation for adjusting the temperature of the ink while circulating the ink without discharging or supplying the ink.

What is claimed is:

1. An inkjet printing apparatus comprising:
an inkjet head configured to discharge ink;
a first tank configured to store ink to be supplied to the inkjet head;
a second tank configured to store ink not consumed by the inkjet head;
an ink circulation path for circulation of ink among the first tank, the inkjet head, and the second tank;
a pressurizer configured to provide the first and second tanks with a pressure for the circulation of ink through the ink circulation path;
a first pressure adjuster configured to adjust a pressure inside the first tank during the circulation of ink; and
a second pressure adjuster configured to adjust a pressure inside the second tank during the circulation of ink.

2. The inkjet printing apparatus according to claim 1, wherein the first tank and the second tank are arranged in positions such that liquid surfaces of ink stored in the first and second tanks are located at almost the same height in a vertical direction in a state open to the air and are located lower than an ink discharge surface of the inkjet head.

3. The inkjet printing apparatus according to claim 1, wherein the first pressure adjuster and the second pressure adjuster are formed as a single unit.
